(19) United States
(12) Patent Application Publication
(10) Pub. No.: US 2017/0287271 A1
(43) Pub. Date: Oct. 5, 2017

(54) GAME OF CHANCE WITH PLAYER PERFORMANCE BASED PRIZE LEVELS AND METHOD

(71) Applicant: F&S Concepts, Inc., Cambellton, FL (US)

(72) Inventors: Stanley Michael Hubbard, Cambellton, FL (US); Frank Walker Wendt, Cambellton, FL (US)

(21) Appl. No.: 15/621,737

(22) Filed: Jun. 13, 2017

Related U.S. Application Data
(63) Continuation of application No. 14/463,634, filed on Aug. 19, 2014, now abandoned.

(51) Int. Cl. G07F 17/32

(52) U.S. Cl. CPC G07F 17/3244; G07F 17/3267; G07F 17/329

(57) ABSTRACT

A process is presented to improve the method of playing bingo. The process allows player interaction to determine potential bonus prize amounts. In the preferred embodiment, the gaming method allows a player to experience various game environments during which the player's game performance is tracked through point tracking systems. A player participates in preliminary point games for a set period of time, and performance is tracked through electronic or manual tracking systems. Once a player finishes playing preliminary point games, he or she must have potential prize points verified. A player's potential bonus prize is correlated to verified prize points accumulated. To compete for set prizes and potential monetary bonuses, a player must take part in the primary game. In the preferred embodiment the primary game is Bonus Bingo which is a unique fast-paced paper bingo game.

### CROSS REFERENCE TO RELATED APPLICATION

This nonprovisional utility patent application is a continuation of application Ser. No. 14/463,634 which was filed on Aug. 19, 2014, pursuant to 35 U.S.C. §120. The entire disclosure of that application is hereby incorporated by reference in its entirety.

### BACKGROUND OF THE INVENTION

Bingo is defined as a game of chance in which players match patterns of numbered squares according to numbers drawn. Gaming systems relating to bingo and related bonus prizes have been in use for decades. In most cases these systems and related patents contend with the bingo ball blower, variations on the bingo game rules, or electronic devices that run computer programs for various games of chance, including bingo, and tracking player performance. The evolution of bingo is largely the result of the many competing options for entertainment available to players and the need for gaming establishments to keep pace. Also, because bingo has elements of chance and is regulated through state and federal laws, differences in these laws have influenced and guided game development on a state by state basis.

### SUMMARY OF THE INVENTION

The various methods of play that are available are limited because they do not offer both individual and socially interactive opportunities for players. Also, some of the current methods are sedentary and require little, if any, physical movement. The inventors of the game of chance and player performance based prize levels and method realized a need for an innovative approach to bingo that matches the entertainment needs of the players in their region and maintains compliance with their local legal requirements. The method developed accomplishes these goals and solves the limitations identified in the related art.

This game of chance and player performance based prize levels and method was developed after evaluating and testing various methods and combinations of gaming programs. The present invention matches the player demand in the area surrounding the bingo pavilion and maintains the traditional elements of bingo that are required by the local laws. The game of chance and player performance based prize levels and method presents a bonus system wherein a player's potential winnings in the traditional bingo game can be enhanced and determined by that player's performance in a series of preliminary point games.

These preliminary point games and the potential point awards can be adjusted depending on a number of factors. For instance, during happy hour or other promotional periods, point values may be doubled. Another example may involve automatic point increases depending on a player's game participation history. Data necessary to determine bonuses and adjustments are maintained or input in the computer network and Central Server which is an integral part of the method. Personal player information can also be included in a database on the Central Server.

An embodiment of the present invention provides an improved method for playing bingo which allows player interaction to determine potential bonus prize amounts. This is accomplished by combining the traditional paper bingo game with both modern electronic devices and other interactive games of chance or skill. The invention relates to the integrated method by which a player can experience a variety of different non-bingo point games that are networked or interconnected and add excitement to the traditional bingo experience. A player's performance on the non-bingo point games is recorded using a computer or manual means. Further, potential point awards can be varied through the network depending on conditions. Because there are a variety of game scenarios within the method, a player can choose his or her preferred mode of entertainment and participate at his or her own pace. By including elements that resemble a casino within the method, players can experience casino type excitement without having to bear the financial risk that often accompanies it.

Embodiments of the present invention include a gaming method that allows a player to experience various game environments during which the player's game performance is tracked through an electronic or manual point tracking system. In addition to tracking player game performance, player game history can also be maintained and used as a basis for rewards. To begin the method, players are assigned free play credit or potential prize points upon registering at the pavilion and when purchasing bingo cards. In one embodiment, a player is provided a bingo card strip which consists of three bingo cards on a single strip. The assigned potential prize points are listed on a Point Voucher. It should be noted, that potential prize points have no cash value; therefore, they may not be redeemed for cash. As more bingo cards are purchased, more potential prize points are assigned to the player. The method does not limit the number of bingo cards that can be purchased by an individual player, and the purchase of more bingo cards increases the player's win probability under the preferred game format known as the Bonus Bingo Game.

For a set maximum amount of time, known as the game-day, players are allowed to participate in preliminary point games which can consist of any game type, either participatory or observatory, that will yield positive or negative outcomes. In the exemplary embodiment, video games, chance games, such as a spinning wheel with prize amounts, and games requiring skill on the part of the player are presented as preliminary point games.

A player's performance on preliminary point games is tracked either electronically or manually. It is also foreseeable that the preliminary point games could be tracked completely through electronic methods. In any case, the amount of a player's potential prize points can either increase or decrease depending on preliminary point game performance; however potential prize points cannot be negative. During certain promotional times, players may be eligible for increased point awards. Further, a player's game history may be maintained and point bonuses or other awards can be provided based on player loyalty.

When a player finishes playing preliminary point games, he or she must have the amount of potential prize points verified at the appropriate preliminary point game verification location. The player will receive a point verification certificate indicating the amount of potential prize points. The player must then proceed to the preferred game location known as the Bonus Bingo area. The player registers with the Bonus Bingo proctor and presents all point verification certificates. In return, the player will receive a Potential Bonus Prize Voucher. The amount of the potential bonus prize is correlated to the amount of potential prize points accumulated. The formulaic conversion of points to bonuses may vary depending on promotions, player loyalty or other considerations. This variation can occur at any time during the game day and at multiple stages of a players gaming experience.

Bonus Bingo Games are held throughout the game-day at a frequency corresponding with the number of active players. For a player to participate and compete for prizes in any Bonus Bingo Game, a player must have purchased at least one bingo card strip during the game-day prior to the start of the game. Once all players are registered and seated, the Bonus Bingo game begins. In the preferred embodiment, Bonus Bingo is a unique fast-paced paper bingo game which is further described herein.

### DESCRIPTION OF THE DRAWINGS

FIG. 1 is an illustration of a bingo card strip 1.

FIGS. 2A & 2B contain a flow chart that illustrates the method and general order of play for players.

FIG. 3 is a Point Voucher 3.

FIG. 4 is a Point Verification Certificate 12.

FIG. 5 is a Potential Bonus Prize Voucher 15.

FIG. 6 is an illustration of the flow of information throughout the method and within the Bingo Pavilion 33.

FIG. 7 is an algorithm for the generation and tracking of points.

### DESCRIPTION OF THE GAMING METHOD

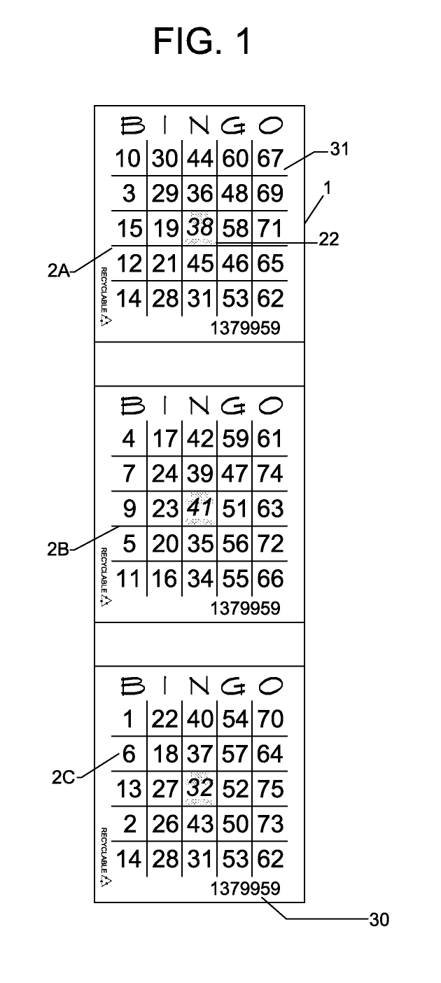

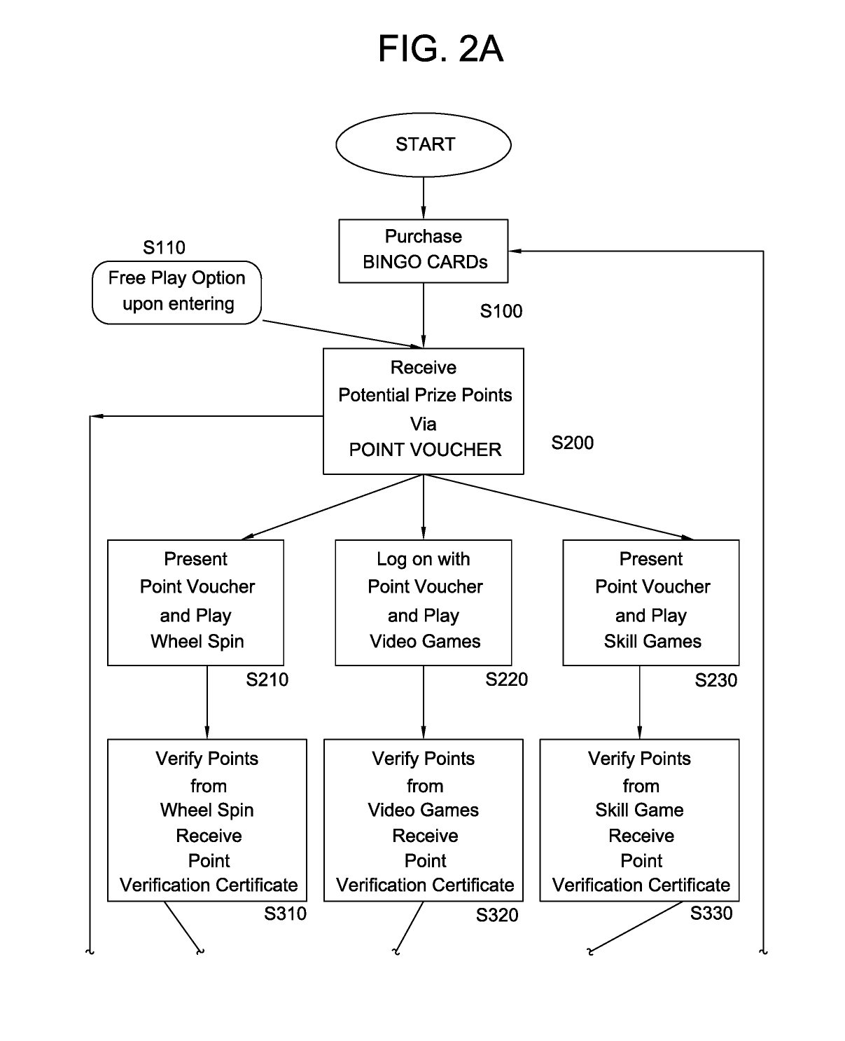

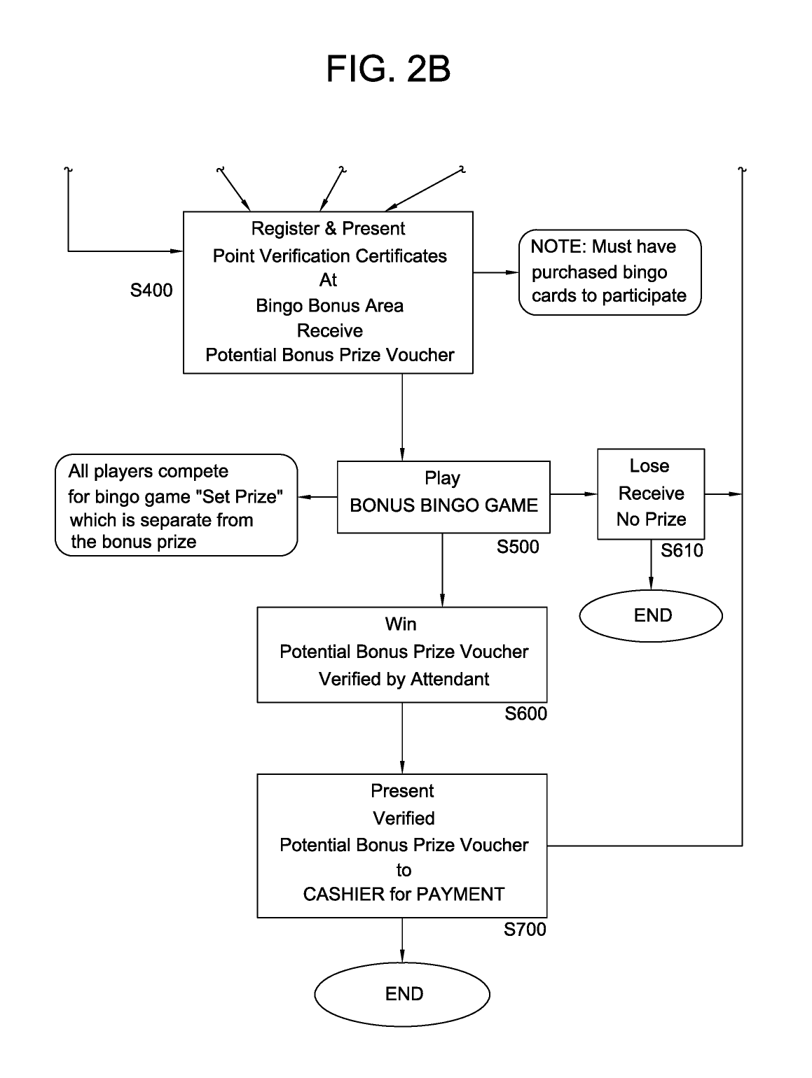

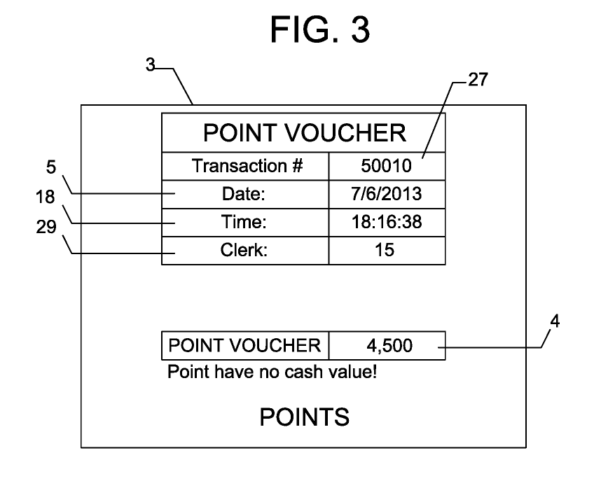

Referring to FIG. 1 and FIG. 2A, a player will begin the method with the purchase of at least one bingo card strip 1 (Step S100) or through registering for the Free Play Option (Step S110). The bingo card strip 1 contains three bingo cards 2A, 2B and 2C. The color of the bingo card strip 1 may vary depending on the level of purchase. Also, each bingo card strip has a unique identification number 30. As shown in FIG. 2A and FIG. 3, a player will be issued a Point Voucher 3 (Step S200) that will indicate the number of points 4 assigned to the player that are valid on the given Game-Day Date 5. A player can also hold multiple Point Vouchers 3 on the same Game-Day.

As shown in FIGS. 2A & 2B, in the preferred embodiment, a player chooses to either participate in preliminary point games that include a wheel spin (Step S210), video games (Step S220), or various skill games (Step S230), or he could go straight to register (Step S400) and play Bonus Bingo (Step S500) following the purchase of a bingo card strip 1 (Step S100) and the receipt of a Point Voucher 3 (Step S200). The variation of the preliminary point game types is by design to appeal to different age groups with diverse player interests. It is possible that a player could participate in all game types (e.g., Steps S210, S220, and S230) on the same Game Day before playing the primary game. Also, other preliminary point game types may be substituted for the three game types presented here depending on player demand and still maintain the spirit of this invention.

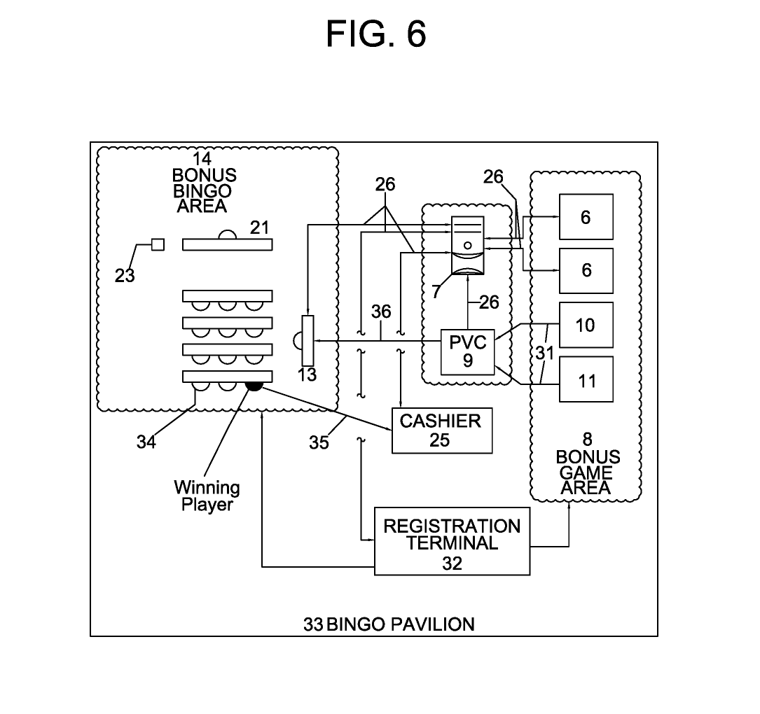

Referring to FIG. 2A & FIG. 6, video games 6 (Step S220) in the Bonus Game Areas 8 are connected via computer network 26 to the Central Server 7 in the Prize Point Verification Center (PVC) 9. As illustrated in FIG. 6, video games can be spread throughout the Bingo Pavilion 33 to encourage player movement. To play video games 6, a player logs into the video games by inputting the Transaction Number 27 presented on a given Point Voucher 3 (Step S220). Throughout play on the video games 6 (Step S220), the player can track his points 4 on the video game screen. Points 4 are added or deducted depending on the game outcome. When the player completes video game 6 play, he logs out of the video game and total points are registered through the computer network 26 to the Central Server 7. A player can choose to log back on to a video game 6 and resume play so long as he has sufficient points to do so. The Wheel Spin 10 (Step S210) and skill games 11 (Step S230) are proctored and operate by manual methods. Referring again to FIG. 2A & FIG. 6, and FIG. 3, for proctored games in the method (Steps S210 & S230), the proctor logs in Point Vouchers 3 from the players and manually notes and certifies point additions or deductions at the completion of the game on each Point Voucher 3. The Wheel Spin 10 and other chance games as well as the skill games 11 may be modified to be electronic and networked while maintaining the spirit of the invention.

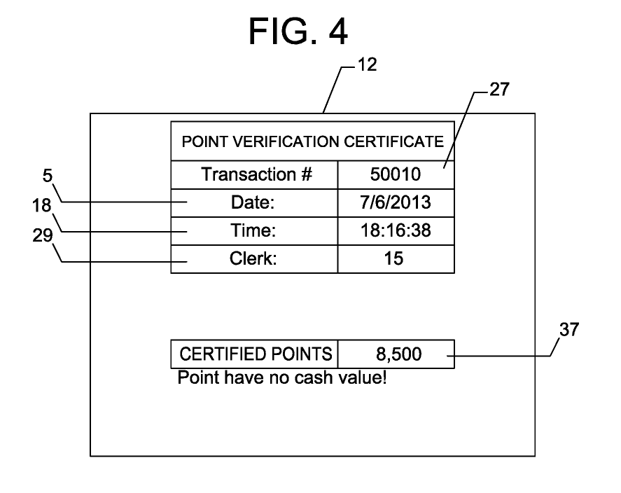

Referring again to FIG. 2A, FIG. 2B, FIG. 3 & FIG. 6, when a player is satisfied with his preliminary point game performance, he will take all Point Vouchers 3 to the PVC 9 to verify point totals from the Wheel Spin 10 (Step S210), video games 6 (Step S220), or skill games 11 (Step S230). Coming from the proctored games (Steps S210 & S230), the player presents 31 his certified Point Vouchers 3 to the PVC 9 for verification (Steps S310 & S330). Under the preferred embodiment, players can have multiple Point Vouchers 3 and each voucher will be associated with a given preliminary point game type. Each Point Voucher 3 is distinguished by a Transaction Number 27. For instance, Transaction Number 27 50010 may be a Point Voucher 3 entitling participation in video games 6. Another Point Voucher 3 with a different Transaction Number 27 may entitle the player to play the Wheel Spin 10. A player can also have multiple Point Vouchers 3 for the same preliminary point game type. For instance, a player may have multiple Point Vouchers 3 for video games 6. For the video games 6 (Step S220), points and player performance are tracked through the computer network 26 by the Central Server 7 and certification by a proctor is not required. The PVC 9 will access and compile all points from all of the preliminary point games and issue Point Verification Certificates 12 to the players (Steps S310, S320, & S330) as shown in FIG. 4. Each player will receive a Point Verification Certificate 12 that corresponds to a verified companion Point Voucher 3 with the same Transaction Number 27. As with the Point Voucher 3, a single player can hold multiple Point Verification Certificates 12 which will remain valid on a given Game Day 5. A player must have certified points 37 provided on at least one Point Verification Certificate 12 as well as at least one bingo card 1 to participate in the primary game.

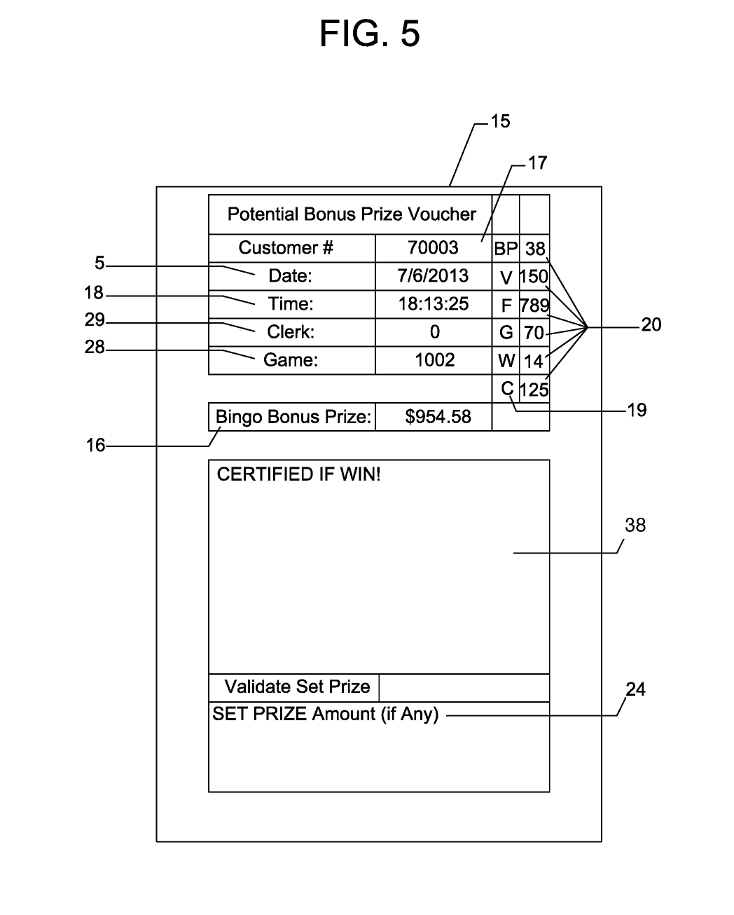

Referring to FIG. 2B, FIG. 4, & FIG. 6 to participate in the primary game, which in this embodiment is a Bonus Bingo game (Step S500), a player registers bingo card strips 1 and presents 36 Point Verification Certificates 12 (Step S400) to the Bonus Bingo proctor 13 in the Bonus Bingo Area 14. The Bonus Bingo proctor 13 inputs the information from each player's Point Verification Certificates 12 to the Central Server 7 through the computer network 26. A player may choose to register any number of valid Point Verification Certificates 12 to play the Bonus Bingo game. As shown in FIG. 5, the Bonus Bingo proctor 13 will provide the player with a Potential Bonus Prize Voucher 15. This Prize Voucher 15 will include the compiled Bingo Bonus Prize 16 based on the Point Verification Certificates 12 registered, the Customer Registration Number 17, the Game-Day Date 5, time of issuance 18, a listing of the Point Verification Certificate Transaction numbers 20 registered and compiled, notes, in column format, as to the corresponding preliminary bonus game types played 19, the Set Prize 24, the Bonus Bingo game number 28, and the code 29 for the clerk issuing the Prize Voucher 15. Referring to FIG. 4, FIG. 5, & FIG. 6, the compiled player certified point 37 to Bingo Bonus Prize 16 conversion is performed by the Central Server 7 based on player data and saved within the Central Server 7.

Referring to FIG. 2B, following the issuance of a Potential Bonus Prize Voucher 15 and the Bonus Bingo proctor 13 confirmation that a player has a bingo card strip 1, the Bonus Bingo proctor gives the player a dauber and the player selects a seat 34 within the bingo bonus area 14. Once all players are seated, the Bonus Bingo announcer 21 begins the Bonus Bingo game (Step 5500) for all of the players with bingo card strips 1 and Prize Vouchers 15. In the exemplary embodiment of the invention, the Bonus Bingo game (Step 5500) is a traditional bingo game; however, it is preferable to increase the speed of the Bonus Bingo game to minimize wait times for future players who have finished preliminary point games and are queued for the next Bonus Bingo game (Step S500).

Referring to FIG. 1, FIG. 2, & FIG. 6, the most effective Bonus Bingo game (Step S500) format used thus far is known as Six-Ball Bingo which is appropriately named as players must achieve a bingo within the first six bingo balls drawn from the bingo ball blower 23 to receive any Bonus Prize 16. As shown in FIG. 1, in the exemplary embodiment, three Bonus Bingo cards 2A, 2B, and 2C are located on a single bingo card strip 1. None of the bingo cards have a center “free space” 22 which is typical of most bingo cards. To win Six Ball Bingo, a player must mark three numbered squares on a single bingo card 2A, 2B, or 2C within the six balls drawn or be the first player to mark three numbered squares. Referring to FIG. 1 & FIG. 6, as the balls are drawn from the bingo ball blower 23, the Bonus Bingo announcer 21 announces the alphanumeric values (e.g., O67 31) one by one. A player must pay attention to the values announced. When one of the values matches a value on the player's bingo card strip 1, the player must physically act by marking his bingo card strip 1 accordingly. A player can fail to pay proper attention or to properly mark his card strip 1, and thereby miss an opportunity to be declared a winning player. If a player daubs over three (3) values on the same bingo card 2A, 2B, or 2C, he should yell, “Bingo!” (Step S600). Referring to FIG. 2B & FIG. 5, the first player to yell bingo wins the Bonus Bingo game (Step 5600) and receives the Set Prize 24 for the winning bingo card 1 plus the Bonus Bingo Prize 16. In the event of a tie (multiple players declare bingo on the same ball alphanumeric value announcement), each winning player will receive his Set Prize 24 divided by the number of winning players plus his Bonus Bingo Prize 16. The Bonus Bingo proctor 13 verifies the Set Prize 24 amount and the Bonus Bingo Prize 16 amounts by stamping a certification stamp and initialing 25 on the Potential Bonus Prize Voucher 15 to certify the winning player(s) (Step S600). The winning player can then take 35 his certified Potential Bonus Prize Voucher 15 to the Cashier 25 to collect payment (Step S700) as further described below.

Again referring to FIG. 1, FIG. 2B, FIG. 5 & FIG. 6, even after a winning player is certified (Step S600), the Bonus Bingo game (Step S500) session continues for other players and bingo balls will continue to be drawn from the bingo ball blower 23 and numbers called until six (6) balls are called. Players continue to daub their registered bingo cards 1. When a subsequent player daubs over three (3) values on the same bingo card 2A, 2B, or 2C, within the six (6) balls, he should also yell, “Bingo!” Players achieving bingo on any of their registered cards after the winning players within the first six (6) balls will win their Bonus Prizes 16 only following certification by the Bonus Bingo proctor 13 (Step S600). These players can also bring 35 certified Potential Bonus Prize Vouchers 15 to the Cashier 25 to collect payment (Step S700) as described below.

Still referring to FIG. 1, FIG. 2B, FIG. 5 & FIG. 6, if six (6) balls are announced and no player wins at that time, the game moves to overtime. The Bonus Bingo announcer 4 continues to call bingo balls until a player achieves Bingo with three (3) values on the same bingo card 2A, 2B, or 2C. The winning players in overtime receive the Set Prize 24 for the winning bingo card 1. In the event of a tie (multiple players declare bingo on the same ball alphanumeric value announcement), each winning player will receive his Set Prize 24 divided by the number of winning players. The Bonus Bingo proctor 13 verifies the Set Prize 24 amount and the Bonus Bingo Prize 16 amounts by stamping a certification stamp and initialing 25 on the Potential Bonus Prize Voucher 15 to certify the winning player(s) (Step S600). If a player fails to daub over three (3) values on the same bingo card 2A, 2B, or 2C within the six (6) balls or following overtime he loses and receives no Bingo Bonus prize 16 (Step S610). Following a loss (Step S610), a player can restart the method or end.

Referring FIG. 2B, FIG. 5 & FIG. 6, winning players take 35 certified Potential Bonus Prize Vouchers 15 to the Cashier 25 to obtain their prize (the Set Prize 24 plus Bonus Prize 16, Bonus Prize 16 alone, or Set Prize 24 alone) (Step S700). The Cashier 38 will verify the player winnings through the Central Server 7 and update player information in the Central Server 7 through the computer network 26. Following cash out (Step S700), a player can restart the method or end.

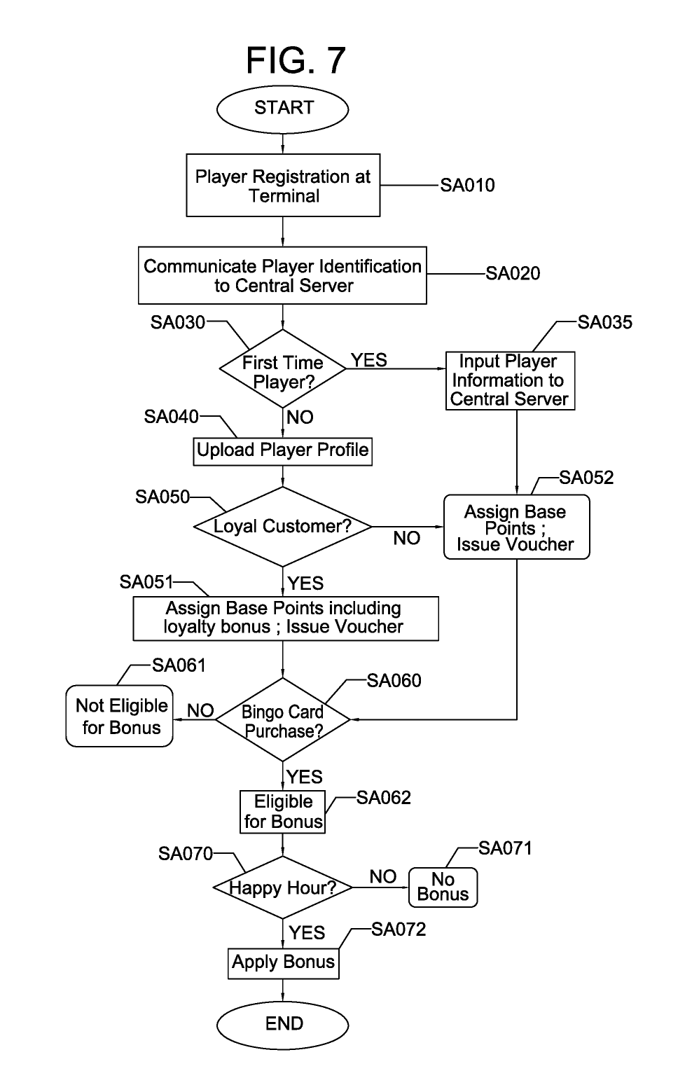

Referring to FIG. 6 & FIG. 7, in one embodiment, player points for preliminary games are determined through an algorithm utilizing player information held on the Central Server 7. Upon entering the Bingo Pavilion 33, a player will register at the Registration Terminal 32 (Step SA010) which can be a kiosk housing a computer. Through the computer network 26 the player identification information will be transmitted to the Central Server 7 (Step SA020). If the player is a first time player (Step SA030: Yes), he will be asked for information that will be uploaded to the player database on the Central Server 7 through the computer network 26 (Step SA035). The player will also be assigned base points (Step SA052) and issued a Point Voucher 3 for playing preliminary games. If the player is not a first time player (Step SA030: No), his player profile will be uploaded (Step SA040). If a player is a loyal customer based on his profile (Step SA050: Yes), he can be assigned base points plus a loyalty bonus (Step SA051) which will appear on his issued Point Voucher 3. If a player has not played often enough or met other conditions to be a loyal customer (Step SA050: No), the player will be assigned base points (Step SA052) which will appear on his Point Voucher 3. Following the assignment of points and issuance of Point Vouchers 3, players will be asked if they would like to purchase a bingo card strip 1 (Step SA060). If a player purchases a bingo card strip (Step SA060: Yes), that player will be issued a bingo card strip 1, and the player will be noted within the Central Server 7 as eligible for the Happy Hour Bonus (Step SA062) or other bonuses if they apply. If a player fails to purchase a bingo card strip (Step SA060: No), the player will not be eligible for the Happy Hour Bonus or other applicable bonuses (Step SA061). This ineligible condition will continue until the player purchases a bingo card strip. As shown in FIG. 2A, once a player receives a Point Voucher 3, he can proceed to the various preliminary point games (Steps 5210, 5220, or S230).

Referring again to FIG. 6 & FIG. 7, if the player is eligible for a Happy Hour Bonus (Step SA062) and it is Happy Hour (Step SA070: Yes), bonuses can be applied to the player's total points. If it is not Happy Hour (Step SA070: No), no bonus will be applied (Step SA071). Happy Hour (Step SA070) and loyalty status (Step SA050) are merely example bonus conditions. Other bonus conditions may be used without departing from the spirit of this invention or disrupting the algorithm. The algorithm is repeated for each new player that enters the Bingo Pavilion 33 and chooses to play the game.

Within the algorithm, the inventors can vary the conditions necessary to determine loyalty status (Step SA050), Happy Hour status (Step SA070) or apply other bonus conditions for points. This can be done electronically through inputs in the Central Server 7 or manually through communication to game proctors. When bonus conditions change within the Game Day 5 for players, the Central Server 7 should be updated to reflect the change of conditions. Player point totals and other player information can be accessed from the Central Server 7 through the computer network 26, throughout the game. As stated, the bonus conditions presented in this algorithm FIG. 7 are merely exemplary and are not representative of all of the various bonus conditions which may be employed through the method.

What is claimed is:

1. A gaming method, comprising:
providing an opportunity to play one or more preliminary games during a set time period;
tracking player performance in the preliminary games through a point system;
converting player points from the preliminary games to a potential monetary bonus; and
providing a primary game with a set prize in addition to the potential monetary bonus.

2. The gaming method of claim 1, wherein the preliminary games and the primary game are sequential.

3. The gaming method of claim 1, where the preliminary games are selected from a group consisting of video games, skill games or chance games.

4. The gaming method of claim 1, where the preliminary games are networked to a central server.

5. The gaming method of claim 1, where the point system comprises the steps of:
determining whether a player has participated in the gaming method previously;
maintaining player profiles in a database;
assigning base points to the player based on his player profile;
recording whether the player purchased at least one bingo card prior to playing the preliminary games;
establishing criteria for increasing or decreasing the base points based on the player's performance in the preliminary games;
designating bonus conditions; and
awarding bonus points if the player purchased at least one bingo card prior to playing the preliminary games and if the bonus conditions are satisfied.

6. The gaming method of claim 4, where the central server conducts tasks comprising:
compiling the player's points from the preliminary games;
awarding bonus points;
converting the player's total points to the potential monetary bonus for the player in the primary game; and
updating the player profile in the database.

7. The gaming method of claim 1, where the primary game comprises a bingo game.

8. A gaming system, comprising:
means for registering a player to play one or more preliminary games during a set time period;
means for maintaining a database of player profiles;
means for providing the preliminary games and a primary game in sequence;
means for comparing the player profiles to set criteria to determine loyalty;
means for assigning base points to the player based on loyalty to play preliminary games;
means for recording whether the player purchased at least one bingo card;
means for tracking a player's performance on the preliminary games through a point system;
means for compiling a player's points from preliminary games;
means for determining whether a bonus condition is satisfied, if so, applying a bonus to points accumulated by the player;
means for validating the player's points; and
means for converting the player's points to a potential monetary bonus for the player in the primary game.

9. The gaming system of claim 8, wherein the preliminary games and the primary game are networked to a central server.

10. The gaming system of claim 8 where the registering means comprises a computer.

11. The gaming system of claim 8 where the registering means comprises a kiosk.

12. The gaming system of claim 8 where the tracking means comprises a computer.

13. The gaming system of claim 8 where the tracking means comprises a voucher system.

14. The gaming system of claim 8 where the primary game is bingo.

15. A gaming system, comprising:
preliminary games and a primary game;
a terminal with a computer to:
register players during a set time period;
assign base points to players;
a server configured to:
store player profiles;
compare player profiles to set criteria to determine loyalty;
record whether players purchase at least one bingo card;
track player performance in the preliminary games through a point system;
determine whether a bonus condition is satisfied, if so, apply a bonus to points accumulated by the player;
validate player points; and
convert player points to a potential monetary bonus for the player in the primary game.

16. The gaming system of claim 15 where the terminal comprises a printer to print player vouchers.

17. The gaming system of claim 15 where the primary game is bingo.

18. The gaming method of claim 1 where the preliminary games can be played over a network from remote locations.

19. The gaming system of claim 8 where the preliminary games can be played over a network from remote locations.

20. The gaming system of claim 15 where the preliminary games can be played over a network from remote locations.
